(19) United States
(12) Patent Application Publication
(10) Pub. No.: US 2013/0302112 A1
(43) Pub. Date: Nov. 14, 2013

(54) QUICK-NUT EXTRACTION

(71) Applicant: Christian Scherer, Weikersheim (DE)

(72) Inventor: Christian Scherer, Weikersheim (DE)

(73) Assignee: ILLINOIS TOOL WORKS INC., Glenview, IL (US)

(21) Appl. No.: 13/981,268

(22) PCT Filed: Jan. 24, 2012
(86) PCT No.: PCT/US12/22329

§ 371 Date: Jul. 23, 2013

(30) Foreign Application Priority Data
Jan. 24, 2011 (DE) 10 2011 010 036.9

(51) Int. Cl. F16B 37/08

(52) U.S. Cl. CPC F16B 37/08
USPC 411/433

(57) ABSTRACT

A device for fastening a component on a carrier component, wherein the component comprises a through opening and the carrier component comprises a fastening projection being guidable through the through opening, including a first fastening element and a second fastening element, wherein first and second fastening elements can be preliminarily connected together and in the state preliminarily connected together form a reception, with which they can be placed on the fastening projection when the fastening projection of the carrier component is guided through the opening of the component, and wherein at least one of the fastening elements comprises at least one contacting surface, wherein the reception for the fastening projection reduces when a pressure is exerted on the at least one contacting surface when the fastening elements being preliminarily connected together are placed on the fastening projection.

The invention relates to a device for fastening a component on a carrier component, wherein the component comprises a through opening and the carrier component comprises a fastening projection being guidable through the through opening. For example, cowling parts are fastened on a body part of an automobile using these types of devices. As a rule, several fastening projections, for example fastening bolts, are arranged, for example welded, on the body part for this purpose. In the case of known devices, the cowling part to be fastened on the body part is pushed on the fastening bolt or fastening bolts by way of its through opening or through openings. These types of fastening bolts can be provided, for example, with an outer thread. A nut or the like is then screwed onto the fastening bolt or fastening bolts such that the component is held between the carrier component and the nut screwed onto the fastening bolt. Using such devices, it is possible to retain the components on the carrier component in operation at high retaining forces. The manner of the mounting of the known devices by means of screw connection, however, is time-consuming.

Proceeding from the prior art explained, the object underlying the invention is to provide a device of the aforementioned type, with which simple and rapid mounting is possible at high retaining forces.

This object is achieved by the invention by the object of claim 1. Advantageous developments are to be found in the dependent claims, the description and the figures.

The object is achieved by the invention by a device for fastening a component on a carrier component, wherein the component comprises a through opening and the carrier component comprises a fastening projection being guidable through the through opening,
comprising a first fastening element and a second fastening element, wherein first and second fastening elements can be preliminarily connected together and in the state preliminarily connected together form a reception, with which they can be placed on the fastening projection when the fastening projection of the carrier component is guided through the opening of the component, and wherein at least one of the fastening elements comprises at least one contacting surface,
wherein the reception for the fastening projection reduces when a pressure is exerted on the at least one contacting surface when the fastening elements being preliminarily connected together are placed on the fastening projection, so that the fastening elements are fastened on the fastening projection.

The carrier component can be a body part of an automobile, for example. The component to be fastened thereon can be a flat component, for example a cowling part to be fastened on the body part. The carrier component and the component can be part of the device as claimed in the invention. The contacting surface of the fastening element or fastening elements can be provided, in particular, only on one of the fastening elements such that said fastening element is pushed, for example, into the other fastening element when a pressure is exerted onto the contacting surface for the final mounting.

As claimed in the invention, particularly simple mounting of the device is made possible by the fastening elements being able to be placed onto the fastening projection of the carrier component in their state preliminarily connected together. The final mounting can then be effected in a simple manner by means of an exertion of pressure onto the contacting surface. The device does not have to be screwed on for this purpose. Time saving during the mounting procedure is achieved as a result. In addition, mounting is possible using a small amount of force. At the same time very high retaining forces are achieved with the device in particular on account of the cross locking of the fastening elements on the fastening projection. The device has a sturdy design which is able to compensate for high fitting tolerances.

Several fastening projections can obviously be provided on the carrier component. In a corresponding manner, the component to be fastened can have several through openings associated with the projections. A device as claimed in the invention can then be provided for each fastening projection. The fastening elements can be realized in each case in one piece. They can be produced from a plastics material, for example. As a result, the device is able to be realized in a particularly weight-saving manner. According to one development that is particularly appropriate in practice, the fastening elements are able to lock together in their preliminarily connected together state. In addition, the first and second fastening elements can be pushed into one another for the preliminary connection.

The device can further comprise a fastening tool, which can be pushed onto the at least one contacting surface for fastening the fastening elements on the fastening projection when the fastening elements being preliminarily connected together are placed on the fastening projection. This exertion of pressure by the fastening tool then brings about the reduction of the reception of the fastening elements. The fastening tool allows for particularly simple and rapid mounting. The fastening tool can consist of a plastics material. The fastening tool can also be pushed onto the fastening elements in the direction of the carrier component. The fastening elements can then be further pushed into one another upon pushing of the fastening tool. The fastening tool can be pushed onto the fastening elements, in particular perpendicular to the surface of the component or carrier component, for example in the axial direction of a fastening bolt as fastening projection. This movement of the fastening tool can generate a movement of the fastening elements towards each other in a direction perpendicular to the direction of movement of the fastening tool. For example, the fastening tool can be moved in the vertical direction for the mounting procedure and as a result can generate a horizontal movement of the fastening elements.

The fastening elements are able to lock together in the finally mounted state being fastened on the fastening projection. In the finally mounted state, therefore, a locking of the fastening elements can be effected which brings about a fixed retaining of the fastening elements and consequently of the component on the carrier component.

As claimed in a further development, the at least one contacting surface can comprise at least one surface being inclined with regard to the insertion direction of the fastening projection into the reception of the fastening elements or at least one conical surface. An inclined surface in this context also includes a surface that is formed in a concave or convex manner, in particular inclined in a concave or convex manner. The contacting surface or contacting surfaces is/are inclined in particular in such a manner that the cross section of the preliminarily connected together fastening elements reduces when seen in the direction of insertion of the fastening projection into the reception of the fastening elements. In this way, when placed onto the preliminarily connected together fastening elements, the fastening tool can initially come into contact with the contacting surface or contacting surfaces and when placed on further, as a result of the inclination of the contacting surface or surfaces, can push the fastening elements further into one another. Several such inclined or conical contacting surfaces can be provided in particular.

As claimed in a development that is particularly appropriate in practice, the fastening projection can be a fastening bolt. In addition, the fastening projection can comprise an outer thread or at least one locking element, wherein at least one of the fastening elements engages with the outer thread or the at least one fastening projection in the state being fastened on the fastening projection. In principle, arbitrary fastening projections are conceivable, for example fastening bolts. However, it is also conceivable for the fastening projections to be mushroom-shaped, spherical or T-shaped. For example, the fastening projections can have a coarse thread, a fine groove or other locking elements. At least one of the fastening elements can then have a corresponding inner thread or corresponding locking elements, by way of which it engages with the outer thread or the locking elements of the fastening projection. The locking elements are locking projections and locking receptions, for example. In the case of this development, self-adjustment of the fastening elements is effected in a direction perpendicular to the insertion direction of the fastening projection into the reception of the fastening elements (for example in the horizontal direction). In particular, when pushed further into one another by means of the fastening tool, the fastening elements automatically move into engagement with the outer thread or the locking elements.

The advantage of locking elements compared to an inner or outer thread is that no unwanted automatic demounting caused by vibrations occurring during the operation, for example of an automobile, can be effected. Contrary to this, the combination of an inner and outer thread allows for simple and destruction-free demounting. In a corresponding manner as claimed in a further development, it can be provided that the fastening elements can be screwed off the fastening projection for the demounting of the component. The screwing off can be effected, in particular, in the state being finally connected together. The fastening tool can be in the shape of a ring such that when the fastening tool is placed onto the fastening elements, a particularly simple and self-adjusting pushing into one another of the fastening elements into the finally mounted position is possible. The fastening element can be in the form of a polygonal ring, for example (for example a hexagonal ring). One or both fastening elements can then be provided, for example, with a corresponding polygonal reception (for example a hexagonal reception) which can be moved into engagement with the polygonal ring for demounting. In the case of such a development, the demounting is able to be effected in a particularly simple manner using the (standard) fastening tool, by said fastening tool being placed onto the fastening elements and then, by rotating the fastening tool, the fastening elements being screwed off the fastening projection.

As claimed in a further development, the first and/or the second fastening element can comprise a contacting surface for contacting a first surface of the component. By way of this contacting surface, the first and/or second fastening element can contact the first surface of the component with the fastening projection of the carrier part guided through the opening of the component and in the state placed on the fastening projection. The contacting surface can be formed by a resiliently elastic contacting disk. This development enables tolerance compensation in the insertion direction of the fastening projection into the reception (for example in the vertical direction).

As claimed in a further development, it can be provided that the device further comprises a holding disk with a through opening for the fastening projection and with a contacting surface for contacting a second surface of the component being opposite to the first surface, wherein preliminary connecting means are provided, with which the fastening elements in the state being preliminarily connected together and the holding disk can be preliminarily connected together without the fastening projection, each in the state contacting the component. The preliminary connecting means can comprise a locking connection. It can additionally be provided that the first and/or the second fastening element comprises an insertion section with a through opening and with at least one locking element and in that the holding disk comprises an insertion section with a through opening and with at least one locking element corresponding to the at least one locking element of the insertion section of the first and/or second fastening element, wherein the insertion section of the first and/or second fastening element and the insertion section of the holding disk can be inserted into one another, wherein the locking elements lock with one another for preliminarily connecting the fastening elements and the holding disk. The insertion sections can be cylindrical.

This development makes it possible to pre-assemble the fastening elements on the component. The component with the fastening elements and the retaining disk can be placed on the fastening projection of the carrier component in this manner. This means that the mounting of the device is further simplified.

An exemplary embodiment of the invention is explained in more detail below by way of figures, in which, in a schematic manner:

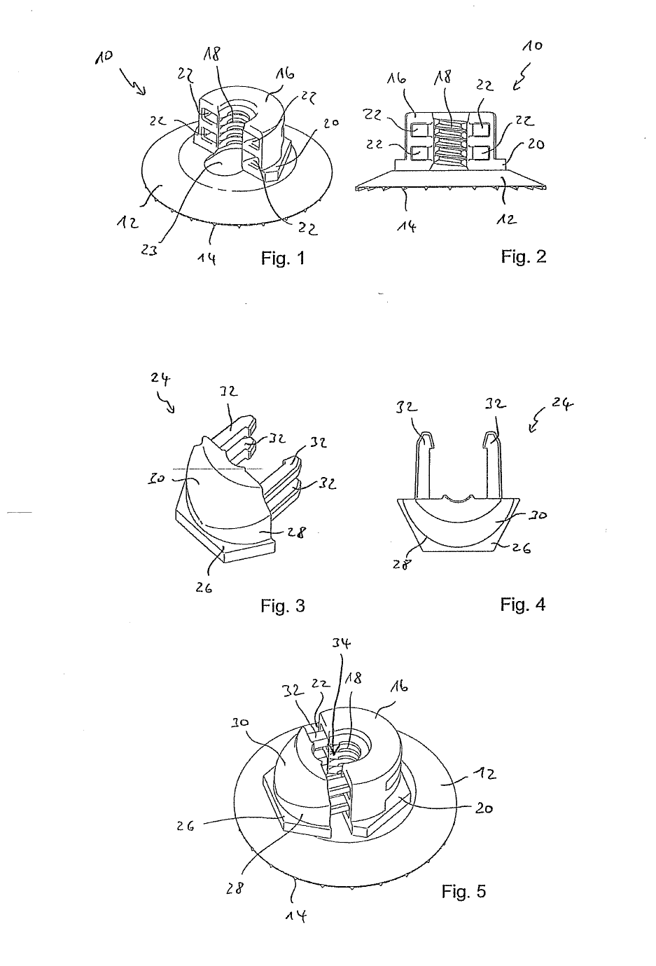

FIG. 1 shows a perspective view of a first fastening element of a device as claimed in the invention according to a first exemplary embodiment,

FIG. 2 shows a side view of the fastening element from FIG. 1,

FIG. 3 shows a perspective view of a second fastening element of a device as claimed in the invention according to the first exemplary embodiment,

FIG. 4 shows a top view of the fastening element from FIG. 3,

FIG. 5 shows a perspective view of the fastening elements from FIGS. 1 to 4 in a state preliminarily connected together,

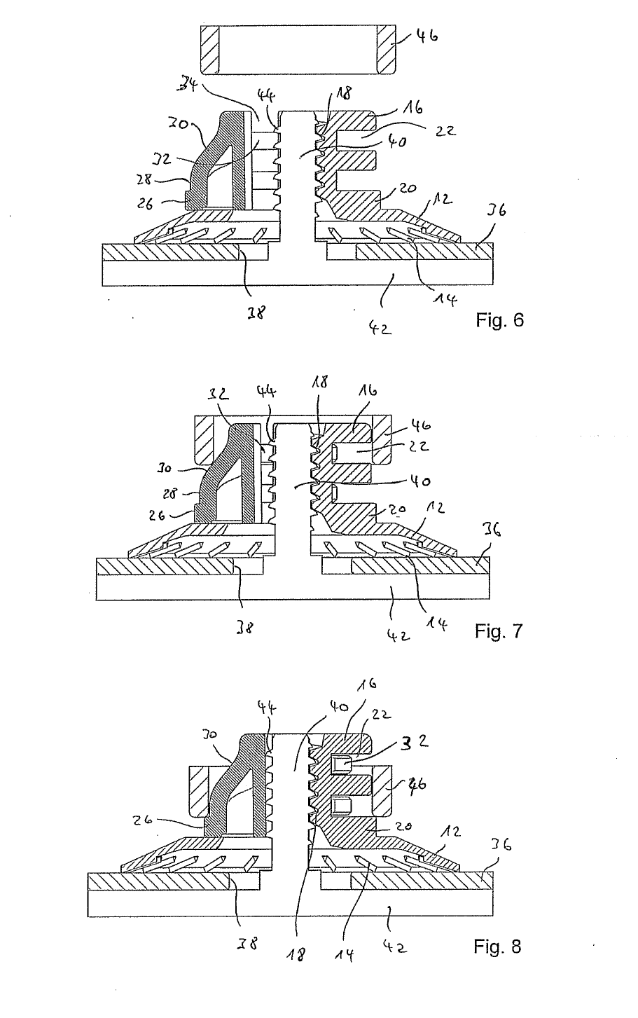

FIG. 6 shows a sectional view of the device as claimed in the invention according to the first exemplary embodiment in a first mounting state,

FIG. 7 shows a sectional view of the device from FIG. 6 in a second mounting state,

FIG. 8 shows a sectional view of the device from FIG. 6 in a third mounting state,

FIG. 9 shows a side view of a first and second fastening element of a device as claimed in the invention according to a second exemplary embodiment in a state preliminarily connected together,

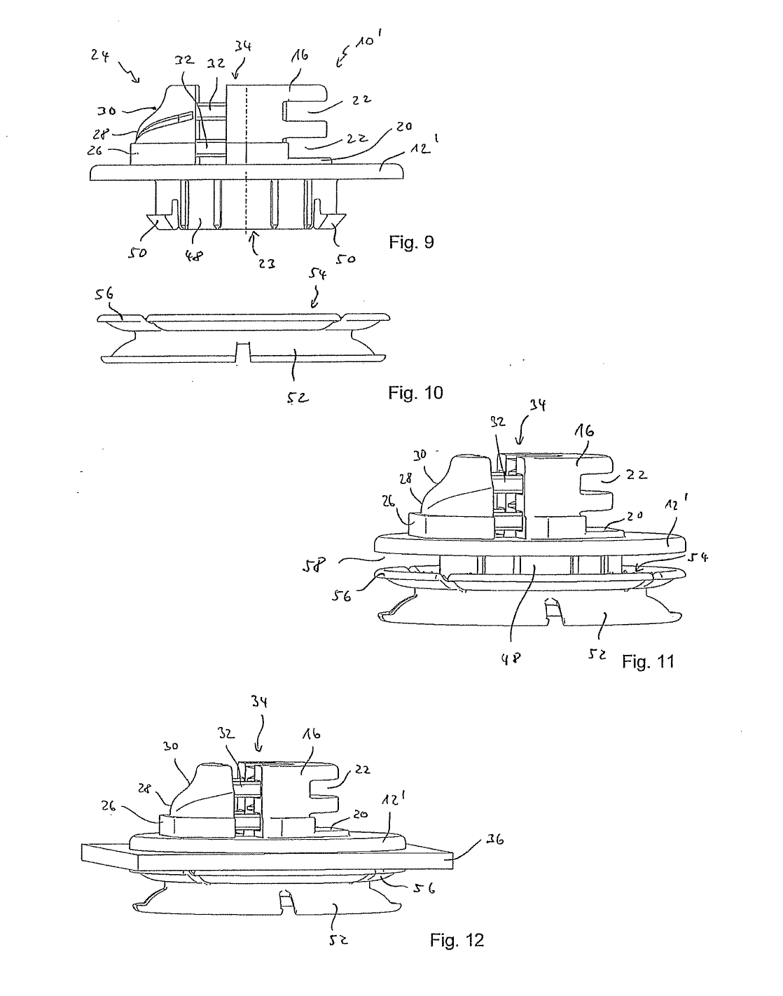

FIG. 10 shows a side view of a holding disk of a device as claimed in the invention according to the second exemplary embodiment,

FIG. 11 shows a perspective view of the device as claimed in the invention according to the second exemplary embodiment in a first mounting state,

FIG. 12 shows a perspective view of the device from FIG. 11 in a second mounting state.

In so far as nothing to the contrary is specified, identical references in the figures refer to identical objects. FIGS. 1 and 2 show a first fastening element 10 of a device as claimed in the invention according to a first exemplary embodiment. The fastening element 10 has an elastic contacting disk 12, which is circular in top view and has several contacting projections 14 arranged distributed on its under side. The contacting projections 14 serve for contacting a component, for example a cowling part, to be fastened on a carrier component, for example on a body part of an automobile. On the side opposite the contacting projections 14, a hollow cylindrical open section 16 extends proceeding from the contacting disk 12. On its inner side, the hollow cylindrical section 16 is provided with an inner thread 18. At the transition between the hollow cylindrical section 16 and the contacting disk 12, there is also part of a hexagonal reception 20. In the example shown, four locking receptions 22, which are substantially rectangular in cross section, are also realized in the open sides of the hollow cylindrical section 16. A central through opening 23 is also provided in the contacting disk 12. FIGS. 3 and 4 show a second fastening element 24. The second fastening element 24 also has part of a hexagonal reception 26 on the under side thereof. A contacting section 28 with an inclined contacting surface 30 extends proceeding from part of the hexagonal reception 26. In particular, the cross section of the second fastening element 24 proceeding from the hexagonal reception 26 is tapered. In the example shown, four locking arms 32 also extend proceeding from the contacting section 28. The first and second fastening elements 10, 24 shown in FIGS. 1 to 4 have been produced from a plastics material, in each case in one piece, in an injection molding procedure.

FIG. 5 shows the preliminarily connected together state of the fastening elements 10 and 24 from FIGS. 1 to 4. To achieve this state, the second fastening element 24 with its locking arms 32 has been pushed laterally into the locking receptions 22 of the first fastening element 10. In this preliminarily connected together state, the locking arms 32 can be preliminarily locked in the locking receptions 22. It can be seen that in the preliminarily mounted state, a continuous reception opening 34 is formed by the fastening elements 10, 24. It can also be seen that a complete hexagonal reception is formed by the hexagonal sections 20, 26 apart from a small space still existing in the preliminarily mounted state.

The fastening of a flat component 36 with a through opening 38, in the present case a cowling part 36, to a carrier component 42, in the present case a body part 42 of an automobile, provided with a fastening projection 40, in this case a fastening bolt 40, is now to be explained by way of FIGS. 6 to 8. In the example shown, the fastening bolt 40 has an outer thread 44. For mounting, the component 36 with its through opening 38 is initially placed onto the fastening bolt 40, the component 36 contacting the carrier component 42. As shown in FIG. 6, the first and second fastening elements 10, 24 are then placed from above onto the component 36 in the preliminarily mounted state shown in FIG. 5, the fastening bolt 40 passing into the reception 34 of the fastening elements 10, 24. A ring-shaped fastening tool 46 shown in FIG. 6 is then used for the final mounting. As can be seen in FIG. 7, said fastening tool is pushed from above onto the fastening elements 10, 24, the under side of the fastening tool 46 coming into contact with the inclined contacting surface 30 of the second fastening element 24. As a result of the inclination of the contacting surface 30, when, in FIG. 7, the fastening tool 46 is pushed further downward vertically, this results, in FIG. 7, in a horizontal movement of the second fastening element 24 and consequently in the second fastening element 24 being pushed further into the first fastening element 10. If the fastening tool 46 is then pushed further down, as shown in FIG. 8, the second fastening element 24 is also pushed further in a corresponding manner into the first fastening element 10 as far as the finally mounted state shown in FIG. 8. The inner thread 18 engages with the outer thread 44 of the fastening bolt 40 no later than at this point. At the same time, the locking arms 32 with the locking sections realized in each case at their free ends move into a locking position in the locking receptions 22 of the first fastening element 10. In this finally mounted state, the diameter of the reception 34 of the fastening elements 10, 24 is reduced to the diameter of the fastening bolt 40. As a result of the locking of the second fastening element 24 in the first fastening element 10, the fastening tool 46 can then be removed upward from the device without the fastening elements 10, 24 being able to become detached from one another again. The component 36 is retained fixedly on the carrier component 42 in this state. The elastic contacting disk 12 with its contacting projections 14, in this case, allows for tolerance compensation in the vertical direction.

It must be pointed out again that the hexagonal sections 26, 20 together form a complete hexagonal reception in the finally mounted state shown in FIG. 8. If the fastening tool 46 is realized, for example, as a hexagonal ring, the device is able to be demounted out of the position shown in FIG. 8 in a simple manner by screwing off the fastening elements 10, 24 from the fastening bolt 40 using this fastening tool 46.

FIGS. 9 to 12 show a device as claimed in the invention according to a second exemplary embodiment. The device according to this exemplary embodiment once again has a first fastening element 10′, which in further parts is realized in an identical manner to the fastening element 10 shown in FIGS. 1 and 2. Over and above this, the device according to FIGS. 9 to 12 has a second fastening element 24, which is realized in an identical manner to the fastening element 24 shown in FIGS. 3 and 4. In FIG. 9, the fastening elements 10′, 24 are shown in their preliminarily connected together state. The preliminary connection is effected in an analogous manner to the manner explained above in regard to FIGS. 1 to 5 such that reference is to be made thereto.

The first fastening element 10′ according to FIGS. 9 to 12 differs from the first fastening element 10 according to FIGS. 1 and 2 on the one hand in that the contacting disk 12′ of the first fastening element 10′ from FIGS. 9 to 12 has no contacting projections and is not realized in a resilient manner. It differs over and above this in that proceeding from the contacting disk 12′ in FIG. 9, a hollow cylindrical insertion section 48 extends downward in FIG. 9. Several locking projections 50 are realized on the free end of the insertion section 48. Over and above this, the device according to the second exemplary embodiment comprises a retaining disk 52, shown in FIG. 10, with a central through opening for a fastening projection. The retaining disk 52 also has an insertion section 54, into which the insertion section 48 of the first fastening element 10′ can be inserted. Over and above this, on its upper side the retaining disk 52 has an elastic contacting section 56, which enables vertical tolerance compensation in the mounted position. As shown in FIG. 11, the first fastening element 10′, in the state preliminarily connected to the second fastening element 24, can be inserted into the insertion section 54 of the retaining disk 52 by way of its insertion section 48. The locking projections 50 of the insertion section 48, in this case, lock into corresponding locking receptions of the retaining disk 52 (not shown). In this preliminarily connected together state of the fastening elements 10′, 24 with the retaining disk 52 shown in FIG. 11, a spacing 58 for a component is formed between the contacting disk 12′ and the elastic contacting disk 56 of the retaining disk 52.

To mount the component 36 on the carrier component 42, the first fastening element 10′, in the state preliminarily connected to the second fastening element 24, is initially pushed through the through opening 38 of the component 36 by way of its insertion section 48. The retaining disk 52 can then be placed onto the insertion section 48 from the under side such that the locking projections 50 of the insertion section 48 lock in the corresponding locking receptions of the insertion section 54 of the retaining disk 52, as shown in FIG. 12. In this state, the device is preliminarily mounted on the component 36. From this state, the device can then once again be mounted on the carrier part 42 in the manner explained above in regard to FIGS. 6 to 8, wherein, contrary to the finally mounted position in FIG. 8, in the case of the exemplary embodiment according to FIGS. 9 to 12, after mounting the retaining disk 52 is situated between the under side of the component 36 and the upper side of the carrier component 42. Demounting can be effected as explained above in regard to the first exemplary embodiment.

1. Device for fastening a component on a carrier component, wherein the component comprises a through opening and the carrier component comprises a fastening projecting being guidable through the through opening,
comprising a first fastening element and a second fastening element, wherein first and second fastening elements can be preliminarily connected together and in the state preliminarily connected together form a reception, with which they can be placed on the fastening projection when the fastening projection of the carrier component is guided through the opening of the component and wherein at least one of the fastening elements comprises at least one contacting surface,
wherein the reception for the fastening projection reduces when a pressure is exerted on the at least one contacting surface when the fastening elements being preliminarily connected together are placed on the fastening projection, so that the fastening elements are fastened on the fastening projection.

2. Device according to claim 1, wherein the fastening elements lock together in the preliminarily connected together state.

3. Device according to claim 1, wherein the first and second fastening element can be pushed into one another for the preliminary connection.

4. Device according to claim 1, wherein it further comprises a fastening tool, which can be pushed onto the at least one contacting surface for fastening the fastening elements on the fastening projection when the fastening elements being preliminarily connected together are placed on the fastening projection.

5. Device according to claim 4, wherein the fastening tool can be pushed onto the fastening elements in the direction of the carrier component.

6. Device according to claim 3, wherein the fastening elements are further pushed into one another upon pushing of the fastening tool.

7. Device according to claim 1, wherein the fastening elements lock with one another in the state being fastened on the fastening projection.

8. Device according to claim 1, wherein the at least one contacting surface comprises at least one surface being inclined with regard to the insertion direction of the fastening projection into the reception of the fastening elements or at least one conical surface.

9. Device according to claim 1, wherein the fastening projection is a fastening bolt.

10. Device according to claim 1, wherein the fastening projection comprises an outer thread or at least one locking element, wherein at least one of the fastening elements engage with the outer thread or the at least one fastening element in the state being fastened on the fastening projection.

11. Device according to claim 10, wherein the fastening elements can be screwed off the fastening projection for demounting of the component.

12. Device according to claim 1, characterized in that wherein the first and/or the second fastening element comprises an elastic contacting disk with a contacting surface for contacting a first surface of the component.

13. Device according to one of the preceding claims, characterized in that the first and/or the second fastening element comprises a contacting surface for contacting a first surface of the component and in that the device further comprises a holding disk with a through opening for the fastening projection and with a contacting surface for contacting a second surface of the component being opposite to the first surface, wherein preliminary connecting means are provided, with which the fastening elements in the state being preliminarily connected together and the holding disk can be preliminarily connected together without the fastening projection, each in the state contacting the component.

14. Device according to claim 13, wherein the preliminary connecting means comprise a locking means.

15. Device according to claim 14, wherein the first and/or the second fastening element comprises an insertion section with a through opening and with at least one locking element and in that the holding disk comprises an insertion section with a through opening and with at least one locking element corresponding to the at least one locking element of the insertion section of the first and/or second fastening element wherein the insertion section of the first and/or second fastening element and the insertion section of the holding disk can be inserted into one another wherein the locking elements lock with one another for preliminarily connecting the fastening elements and the holding disk.
